(19) United States
(12) Patent Application Publication
(10) Pub. No.: US 2017/0055537 A1
(43) Pub. Date: Mar. 2, 2017

(54) FROZEN PRE-FRIED DOUGH AND PROCUREMENT PROCESS

(71) Applicant: ALICORP S.A.A., Lima (PE)

(72) Inventors: Alexander Moran Delgado, Lima (PE); Marilu Esperanza Mondragon Arbocco, Lima (PE); Ana Gloria Troncoso Nunez, Lima (PE)

(21) Appl. No.: 15/307,934

(22) PCT Filed: May 20, 2015
(86) PCT No.: PCT/PE2015/000006

§ 371 Date: Oct. 31, 2016

(30) Foreign Application Priority Data
May 21, 2014 (PE) 725-2014/DIN

(51) Int. Cl. A21D 13/08; A21D 6/00; A21D 2/16; A21D 2/18; A21D 2/36; A21D 8/02; A21D 13/00

(52) U.S. Cl. CPC A21D 13/08; A21D 8/02; A21D 6/001; A21D 13/0096; A21D 2/181; A21D 2/36; A21D 2/165

(57) ABSTRACT

The invention relates to a frozen pre-fried dough in ring form that is crispy on the outside and soft on the inside, characterised in that it comprises: a) liquid ingredients: 14.63-18.85% frozen yellow sweet potato pulp, 4.88-11.31% frozen winter squash (Cucurbita maxima Duch.) pulp, 0.49-075% frozen grated cassava, 0.49-075% frozen banana (platano de la is/a) cut into round slices; b) dry ingredients: 3.58-4.14% sugar, 0.005-0.019% sweetener, 1.31-1.46% fresh yeast, 0.49-0.75% vanilla essence, 0.049-0.075% seeds, 0.24-0.38% aniseed and 9.42-9.75% vegetable oil; c) between 32.0-39.0% wheat pastry flour; and e) between 20.74-24.38% water. The invention also relates to a process for making the pre-fried frozen dough in ring form, comprising the steps of: i) homogenising all of the liquid ingredients by mixing them; ii) kneading the liquid mixture; iii) fermenting the dough in a chamber, controlling the temperature and humidity; iv) cutting the dough; v) frying the rings of dough; vi) draining the rings; vii) cooling the units; viii) freezing the rings of pre-fried dough; ix) packaging the product; and x) storing the sealed product.

### INVENTION FIELD

The present invention is related to the food industry; particularly, with a frozen pre-fried dough and its production process.

The frozen pre-fried dough is a product whose presentation are irregular rings, crisp outside and soft inside, which are ready to fry and serve in less than 2 minutes as a dessert, often known as “picaron”. That frozen pre-fried dough is made from a process which increases the storage time of the product while maintaining the quality of the frozen pre-fried dough from an industrial equipment with characteristics similar to those conferred by a picaron-maker and the sweetness of the frozen pre-fried dough in optimum level of fermentation, even though the yeast has consumed a large portion of sugar from the dough.

### STATE OF THE ART

“Picarones” are sweet fried dough, crisp outside and soft inside, in irregular shaped rings and typical of Peruvian cuisine.

In the state of the art many traditional recipes of picarones of typical Peruvian cuisine are described, which includes vegetable ingredients such as sweet potato and pumpkin puree, flour, vegetable oil, sugar and yeast among others, to conform the picaron dough.

Similarly, patents patents as CN 101238825 can be found which describes a method for making a braided pre-fried dough, wherein steps such as kneading, leavening, cutting, frying and freezing are established. Unlike the present application, in this patent the same ingredients described in the present application are not used therefore the same product is not obtained. Furthermore, the conditions for each of the steps described in the patent CN 101238825 are not the same as those described in this application.

In the present invention, both constituents of the dough as variables of the process steps to obtain said pre fried dough, allow to increase the storage time of the final product and obtain a product for consumption with similar characteristics obtained manually with the typical process of a picaron-maker, i.e., a woman who prepares and offers picarones.

### Solution to the Technical Problem

As pointed out before, the problem lies in finding a frozen pre-fried dough having a longer storage time and at the same time maintaining similar characteristics to those obtained when preparing a dough manually.

To overcome the technical problem, a frozen pre-fried dough is presented with a dough quality which is preserved five to six months where the food product has a presentation in the form of rings, which is ready to fry and serve in less than 2 minutes with dough characteristics very similar to a product obtained manually.

To prepare the pre fried dough is necessary a process wherein parameters required are kept strictly controlled to ensure the homogeneity of the product and preserve its distinguishing flavor and texture characteristics, which allows a pre fried dough that is preserved for a longer time than pre fried dough known in the state of the art.

This product is a frozen pre-fried dough that is easy to cook. This allows the mass-consumption of this product while at the same time provides a varied offer for restaurants and main market of this product as well as the consumer.

### SUMMARY DESCRIPTION OF THE INVENTION

The present invention consists in a dessert of frozen pre-fried dough which has wheat pastry flour, sugar, water, frozen yellow sweet potato pulp, frozen macre pumpkin pulp, frozen grated white yucca, frozen island banana slices, sweetener, fresh yeast, vanilla essence, various seeds (linseed, sesame, chia seed), aniseed and vegetable oil, where said frozen pre-fried dough shaped irregular rings, is crisp outside and soft inside.

Furthermore, the present invention also has a process to obtain that frozen pre-fried dough that include homogenizing, kneading, fermentation, cutting, frying, draining, cooling, freezing, packaging and sealing, and storage.

### DESCRIPTION OF THE FIGURES

FIG. 1 is a flowchart describing the procurement process of the pre fried dough.

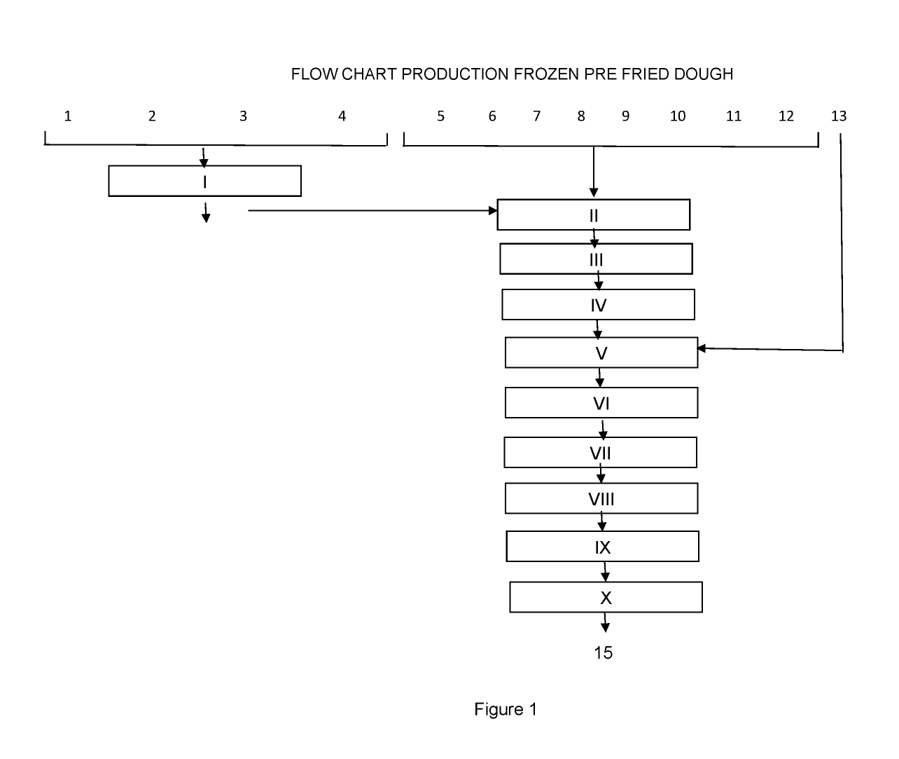

### DETAILED DESCRIPTION OF THE INVENTION

The present invention discloses a frozen pre-fried dough which consists:
a) Liquid ingredients: 14.63 to 18.85% of frozen yellow sweet potato pulp, pulp from 4.88 to 11.31% frozen macre pumpkin pulp, 0.49 to 075% of frozen grated white cassava, 0.49-0.75% of frozen island banana slices;
b) dry ingredients: 3.58-4.14% sugar, sweetener from 0.005 to 0.019%, from 1.31 to 1.46% of fresh yeast, 0.49 to 0.75% of vanilla essence, 0.049-0.075% of seeds, 0.24 to 0.38% of aniseed and 9.42 to 9.75% of vegetable oil;
c) between 32.0 to 39.0% wheat pastry flour; Y
d) between 20.74 to 24.38% of water.

To make the pre-fried dough, you can use the following process that has the following phases:

i. Homogenization

The liquid ingredients are mixed resulting in a liquid unified mixture in an appliance for example an industrial blender.

ii. Kneading

The liquid dough, dried ingredients, and a third of total water are mixed in a dough mixer generating air incorporation to the dough in order to obtain a dough with defined characteristics for picarones, so first use velocity 1 during 2 to 4 minutes to mix softly the dough, then add flour and remaining two thirds of water in a velocity 2 during 3 to 6 minutes where the velocity 1 is always less than velocity 2. Therefore, that gets the maximum increase in dough volume and the defined quality characteristics for dough, that is to say, physics characteristics in distance and travel time from 2 cm in 1 minute to measure with a flat consistometer, and organoleptic characteristics: soft, light, and it does not cut abruptly when you leave falling portion while opening your hand and sweet without acid flavor.

iii. Fermentation

The dough is carried out to chamber conditions to be fermented between 2 to 3 hours where the temperature is controlled and maintained between 24° C.-25° C. and the relative humidity of the environment between 78%-82%. This fermentation process involves gas generation in dough with successive increase volume at the same time the characteristic flavor and smell of the frozen pre-fried dough.

iv. Cutting

The dough is put in dough sheeter that cuts between 30 and 34 grams in circular shapes little irregular in rings through operator's manual action who handles the equipment.

v. Frying

The dough rings are fried for the same time each side (between 40 and 60 seconds) in hot oil at temperature between 175° C. to 180° C. In this phase, it is used as equipment a continuous fryer.

vi. Dripping

In the same fryer, once the rings finished being fried, they are taken by sifted surface belt to drip the oil.

vii. Cooling

The units already dripped are cooled at environment temperature until get a temperature between 40° C. and 60° C. in ring center.

viii. Freezing

The pre-fried rings are taken to tunnel freezer to get a temperature between −20° C. and −10° C. in ring center.

ix. Packaging and Sealing

The product is packaged by operator in sealed pouches from 12 to 20 units.

x. Storage

The product is stored in a freezing chamber to less than −18° C.

Finally, it is obtained a pre-fried dough that its shape is like irregular rings, crisp outside and soft inside, where that pre-fried dough is ready to be fried and served in less than 2 minutes as a dessert most known as picaron.

### Use of Sweetener

The sweetener is used with the purpose of providing the dough a sweetness level in order to standardize the taste of the product. Unlike sugar, ingredient that is also found in the composition, sweetener does not decrease the concentration inside of the composition of the frozen pre-fried dough, as it occurs with sugar that is food of yeast is consumed as the fermentation of the dough advances.

Due to the parameters of fermentation used: temperature between 24° C. and 25° C., relative humidity between 78% and 82% and the time between 2 and 3 hours, different sensory panels were made to validate the sweetness level in the final product, significant differences were not found between the ranges of the established parameters.

### Use of Yucca and Banana

Within the formula of the frozen pre-fried dough was to provide a differential in flavor without detract the main ingredients that make it up: sweet potato and pumpkin that's why cassava and banana were chosen to be used. Cassava is a root rich in carbohydrate, foot of the yeast, as well as its flavor is soft and it combines well with any vegetable. On the other hand, banana is also a fruit rich in carbohydrate but with a very special sweetness and flavor due to its multiple organic components. Both were from different sensory panels the best combination to complement the main ingredients of the formula providing its own personality and flavor of the final product.

The results of the sensory evaluation are in the following table:

TABLE 1

| | | Average results of the evaluation | | | |
|---|---|---|---|---|---|
| Feature | Specification | Time 0 | Month 2 | Month 4 | Month 6 |
| Odor | 1.00 | 1.00 | 1.00 | 1.00 | 1.00 |
| Color | 1.00 | 1.00 | 1.00 | 1.00 | 1.00 |
| Flavor | 1.00 | 1.00 | 1.00 | 1.00 | 1.00 |
| Texture | 1.00 | 1.00 | 1.00 | 1.00 | 1.00 |

*Average results issued by 10 panelists.

Sensory evaluation scale consists in the following:

1. Equal to the pattern

2. Slightly different

3. Moderately different

4. Very different

5. Extremely different

The results of the physiochemical evaluation are described in the following table:

TABLE 2

| | | Average results of the evaluation | | | |
|---|---|---|---|---|---|
| Feature | Specification | Time 0 | Month 2 | Month 4 | Month 6 |
| Humidity | Max. 42.0% | 40.90 | 40.90 | 41.30 | 41.70 |
| (%) | | | | | |

The results of the microbiology evaluation are in the following table:

TABLE 3

| | | | | Average evaluation results | | | | | | | |
|---|---|---|---|---|---|---|---|---|---|---|---|
| Feature | Specification | | Method of analysis | Time 0 | | Month 2 | | Month 4 | | Month 6 | |
| Molds | 10³ | ufc/g | AOAC Official | 20 × 10 | ufc/g | 20 × 10 | ufc/g | 22 × 10 | ufc/g | 22 × 10 | ufc/g |
| | | | Method 997.02 | | | | | | | | |
| | | | Count on yeasts | | | | | | | | |
| | | | and molds food | | | | | | | | |
| E. coli | 10 | ufc/g | AOAC Official | <10 | ufc/g | <10 | ufc/g | <10 | ufc/g | <10 | ufc/g |
| | | | Method 991.14 | | | | | | | | |
| | | | count in coliform | | | | | | | | |
| | | | and Escherichia coli | | | | | | | | |
| | | | food | | | | | | | | |
| Staphylococcus | 10² | ufc/g | FDA Bacteriological | <10 | ufc/g | <10 | ufc/g | <10 | ufc/g | <10 | ufc/g |
| Aureus | | | Analytical Manual | | | | | | | | |
| | | | Online. Hypertext | | | | | | | | |
| | | | Source, c 12, 8th | | | | | | | | |
| | | | Ed. Revision A. | | | | | | | | |
| | | | 1998 January 2001. | | | | | | | | |
| | | | Staphylococcus | | | | | | | | |
| | | | aureus. | | | | | | | | |
| | | | Direct Plate Count | | | | | | | | |
| | | | Method | | | | | | | | |

| | | | | | | |
|---|---|---|---|---|---|---|
| Salmollena sp. | Absence/25 g | Bacteriological | Absence/25 g | Absence/25 g | Absence/25 g | Absence/25 g |
| | | Analytical Manual | | | | |
| | | BAM -Chapter 5 | | | | |
| | | salmonella | | | | |

According with Standard Microbiological Criteria No. 591-2008/MINSA, Group V Cereal grains, legumes quenopodiáceas and derivatives (flours and others), Subgroup 5.5 Pasta and fresh precooked dough and/or pre-cooked with stuffed or frozen (wantan, lasagna, ravioli, cannelloni, pizzas, minpao, others)

According to the results of sensory evaluation, physicochemical and microbiological of the product obtained from the study of storage time, parameters are within specified not having substantial changes therein, therefore it can be concluded that the lifetime of the frozen pre fried dough product is at least 6 months under the storage conditions indicated, during this time being fit for human consumption.

### APPLICATION EXAMPLES

### Example 1

### Preparation of a Frozen-Pre Fried Dough Typical Batch

To prepare a frozen pre fried dough batch of 21 kg, the first thing that was done was homogenizing the vegetable pulps: sweet potato and pumpkin, 3, 80 kg and 1, 80 kg respectively, such as the yucca and banana, 0.16 kg and 0.15 kg respectively, prior thawed. Once this dough was ready, it was placed in a kneader along with the other ingredients: vanilla essence 0.15 kg, seeds (sesame) 0.014 kg, aniseed 0.074 kg, sugar 0.92 kg, sweetener 0.0015 kg, yeast 0.33 kg and a third part of water (1.8 kg), and it was kneaded at a rate 1 of 50 strokes per minute for 3.5 minutes. When the homogenous mixture was obtained, add flour 8.20 kg along with the two thirds of remaining water, and kneading was continued at a rate 2 of 73 strokes per minute for 4.5 minutes until obtain the quality dough with the features already defined. The strokes per minute correspond to the move of the kneader arms performed per minute.

Then, the dough passed to fermentation for 3 hours in temperature conditions 25° C. and relative humid 80%, and once the established time was finished, the cutter was carried to obtain the units of 31 kg of weight that were fried in hot oil at 180° C. The pre fried dough units was cooled to 50° C. and then frozen until obtain a temperature of −20° C. in the center of product, once ready, they were packaged for 20 units and stored at −18° C.

### Example 2

The quality dough has an important impact in the features of final product, thus from the beginning the manually made dough was managed as standard with the typical process of a picaron-maker and then was characterized. When we talk about a picaron-maker, we refer to a woman who prepares and offers picarones.

To characterize the pre fried dough of this request, 3 parameters were measured:
Distance and time of the dough route, before and after kneading
Increase of the dough volume after the fermentation
Density of the final product (frozen pre fried dough rings)
Each one of the tables which are described below, summarize the performed tests and final results obtained for each one of the parameters above mentioned.
For each one of the tests which are showed below, a dough size of 21 kg was employed, wherein the used rates are as follows:
Rate 1 is equal a 50 strokes per minute
Rate 2 is equal a 73 strokes per minute.

TABLE 4
Distance and time of the dough's route, before and after of the kneading

| Parameter | Picaron-maker | Alicorp Dough-Product | | | | Material/ |
|---|---|---|---|---|---|---|
| control | Dough-Product | Test 1 | Test 2 | Tests | Final test | equipment used |
| Distance and | 2 cm - 1 cm | 1.5 cm - 1 | 1 cm - 1 | 1.75 cm - 1 | 2 cm - 1 | Flat |
| time of the route | | min | min | min | minute | consistometer |
| (before the | | | | | | |
| fermentation) | | | | | | |
| Distance and | 2 cm - 1 cm | 1.5 cm - 1 | 1 cm - 1 | 1.75 cm - 1 | 2 cm - 1 | Flat |
| time of the route | | min | min | min | min | consistometer |
| (after the | | | | | | |
| fermentation | | | | | | |
| Observations | Manual | The rate 1 was | The rate 2 was | The rate 1 and | The rate 1 and | — |
| | Method | only employed | only employed | 2 in combination | 2 in combination | |
| | | (slow) for | (fast) for | were employed, | were employed | |
| | | 8 minutes | 8 minutes | 5 minutes and | 3.5 minutes and | |
| | | | | 3 minutes | 4.5 minutes | |
| | | | | respectively | respectively | |

TABLE 5
Increase of the volume of dough after the fermentation

| Parameter | Picaron-maker | Alicorp Dough-Product | | | | Material/ |
|---|---|---|---|---|---|---|
| control | Dough-Product | Test 1 | Test 2 | Test 3 | Final test | equipment used |
| Increase of the | 120%-130% | 110%-115% | 90%-100% | 115%-120% | 120%-130% | Metal rule, |
| volume of dough | | | | | | container |
| (Maximum value | | | | | | for the dough |
| reached) | | | | | | |
| Observations | Manual | The rate 1 was | The rate 2 was | The rate 1 and | The rate 1 and | Calculated |
| | method | only employed | only employed | 2 in combination | 2 in combination | volume from |
| | | (slow) for | (fast) for | were employed, | were employed | cylinder formula |
| | | 8 minutes | 8 minutes | 5 minutes and | 3.5 minutes and | |
| | | | | 3 minutes | 4.5 minutes | |
| | | | | respectively | respectively | |

TABLE 6
Density of the product final (Frozen pre fried dough rings)

| Parameter | Picaron-maker | Alicorp Dough-Product | | | | Material/ |
|---|---|---|---|---|---|---|
| control | Dough-Product | Test 1 | Test 2 | Test 3 | Final test | equipment used |
| Density | 0.38-0.42 | 0.44-0.46 | 0.46-0.48 | 0.43-0.44 | 0.40-0.41 | Analytic balance, |
| | g/ml | g/ml | g/ml | g/ml | g/ml | test tube, container, |
| | | | | | | short pasta in blocks |
| Observations | Manual | The rate 1 was | The rate 2 was | The rate 1 and | The rate 1 and | Calculated density |
| | method | only employed | only employed | 2 in combination | 2 in combination | from the weight of |
| | | (slow) for | (fast) for | were employed, | were employed | the unity measured |
| | | 8 minutes | 8 minutes | 5 minutes and | 3.5 minutes and | between the volume |
| | | | | 3 minutes | 4.5 minutes | moved by that same |
| | | | | respectively | respectively | unity |

What is claimed is:

1. A frozen pre fried dough shaped rings, crisp externally and soft inside, comprising:
a) Liquids ingredients: 14.63-18.85% of frozen yellow sweet potato pulp, 4.88-11.31% of frozen macre pumpkin pulp, 0.49-0.75% of frozen grated white yucca, 0.49-0.75% of frozen sliced island banana;
b) Dry ingredients: 3.58-4.14% of sugar, 0.005-0.019% sweetener, 1.31-1.46% of fresh yeast, 0.49-0.75% of vanilla essence, 0.049-0.075% of seeds, 0.24-0.38% of aniseed and 9.42-9.75% of vegetable oil
c) Between a 32.0-39.0% wheat pastry flour; and
d) Between a 20.74-24.38% of water.

2. A frozen pre fried dough shaped rings in accordance with the claim 1, wherein the seeds used can be chosen from linseed, sesame seeds and/or chia.

3. A frozen pre fried dough shaped rings in accordance with the claim 1, comprising the following liquid ingredients: 380 kg of frozen yellow sweet potato pulp, 1.80 kg of frozen macre pumpkin pulp, 0.16 kg of frozen grated white yucca and 0.5 kg of frozen sliced banana island.

4. A frozen pre fried dough shaped rings in accordance with the claim 1, comprising the following dry ingredients: 0.15 kg of vanilla essence, 0.014 kg of seeds, 0.074 kg of aniseed, 0.92 kg of sugar, 0.0015 kg of sweetener and 0.33 of fresh yeast.

5. A frozen pre fried dough shaped rings in accordance with the claim 4, wherein the seeds are sesame.

6. A frozen pre fried dough shaped rings in accordance with the claim 4, comprising 8.20 kg of flour and 5.4 kg of water.

7. A development process of the frozen pre fried dough shaped rings, comprising the stages of:
I. Homogenize mixing all the liquid ingredients so as to obtain a uniform liquid mixture;
II. Kneading the obtained liquid mixture in the stage (I) along with all the dry ingredients and a total water third on a kneader of vertical arms at a rate 1 during 2 to 4 minutes and then add flour and the remaining two thirds of water to knead again at a rate 2 during 3 to 6 minutes, wherein the rate 1 is always less at the rate 2;
III. Fermenting the dough in a camera controlling that the temperature remains between 24° C.-25° C. and the relative humid of the environment being between 78%-82%;
IV. Cutting the dough in a cutting machine which throw between 30 and 34-gram ring-shaped little irregular circular units, that is managed manually by an operator;
V. Frying the dough rings by the same time in each side, in a hot oil at temperature between 175° C. to 180° C. in a fryer;
VI. Draining the rings at the end of frying, rising with a screened surface belt so that the oil drain;
VII. Cooling the units already drained en plates at room temperature until reach a temperature between 40° C. and 60° C. in the center of the ring;
VIII. Cooling the pre fried dough rings in a freezing tunnel until reach a temperature in the center of the ring of between −20° C. and −10° C.;
IX. Packaging the product by an operator in bags of between 12 and 20 units and seal;
X. Storing the product already sealed in bags in a freezing camera a less of −18° C.

8. A process according with the claim 7, wherein in stage (I) of homogenization, the liquid ingredients are mixed using an industrial blender.

9. A process according with the claim 7, wherein in stage (V), a continue fryer is used as an equipment.

10. A process according with the claim 7, wherein in stage (II) was kneaded with a rate 1 of 50 strokes per minute for 3.5 minutes.

11. A process according with the claim 10, wherein how much is obtained the homogeneous mixture, by adding flour and water, in the stage (II) is kneaded at a rate 2 of 73 strokes per minute for 4.5 minutes.

12. A process according with the claim 11, wherein the dough passes to the stage (III) of fermentation for 3 hours in conditions of 25° C. of temperature and 80%, of relative humid.

13. A process according with the claim 12, wherein once the fermentation be finished, the dough goes to the stage (IV) to cut it in little irregular circular-shaped rings and obtain units of 31 g of weight.

14. A process according with the claim 13, wherein the units are fried once sliced according with the stage (V) in hot oil at 180° C.

15. A process according with the claim 14, wherein the dough units are cooled after being fried according with the stage (VI) until a temperature of 50° C. in the center of ring.

16. A process according with the claim 15, wherein the pre fried dough units already fried are cooled according with the stage (VII) until obtain a temperature of −20° C. in the center of product.

17. A process according with the claim 16, wherein are packaged once cooled according with the stage (IX) in 20 units and after in accordance with the stage (X) are stored at −18° C.
